(19) United States
(12) Patent Application Publication
(10) Pub. No.: US 2025/0272570 A1
(43) Pub. Date: Aug. 28, 2025

(54) METHOD AND APPARATUS FOR LEARNING NEURAL NETWORK MODEL BASED ON DISTRIBUTED LEARNING FRAMEWORK FOR EACH NODE OF HIERARCHICAL TREE-STRUCTURED NETWORK

(71) Applicant: Korea University Research and Business Foundation, Seoul (KR)

(72) Inventors: In Kyu LEE, Seoul (KR); Min Tae KIM, Seoul (KR); Sang Won HWANG, Seoul (KR)

(21) Appl. No.: 18/786,795

(22) Filed: Jul. 29, 2024

(30) Foreign Application Priority Data
Feb. 27, 2024 (KR) 10-2024-0027642

(51) Int. Cl. G06N 3/096; G06N 3/045

(52) U.S. Cl. CPC G06N 3/096; G06N 3/045

(57) ABSTRACT

The present invention relates to a distributed optimization technique for learning a neural network model based on a distributed learning framework embedded in each node, for each node constituting a hierarchical tree-structured network.

### CROSS-REFERENCE TO RELATED APPLICATION

The present application claims the benefit of priority to Korean Patent Application No. 10-2024-0027642, filed on Feb. 27, 2024, in the Korean Intellectual Property Office, the entire contents of which is incorporated herein for all purposes by this reference.

### BACKGROUND OF THE INVENTION

### Field of the Invention

The present invention relates to a distributed optimization technique for learning a neural network model based on a distributed learning framework embedded in each node, for each node constituting a hierarchical tree-structured network.

### Background of the Related Art

Recently, wireless communication systems are required to support higher data rates to meet the demand for new and diverse services. Meanwhile, as consumption of network energy increases significantly to improve the data rate of wireless communication systems, network operators are seeking methods for improving and optimizing energy efficiency environmentally and economically sustainable while supporting the new and diverse services.

Particularly, in order to enhance energy efficiency, the data rate for transmission from a base station to a terminal should be increased while reducing consumption of network energy in the entire wireless communication system. One of the most basic methods for reducing the total energy consumption is to power off the base station, but this may generate loss of data rate.

Accordingly, an optimization technique for controlling power status of each base station constituting a wireless communication system, a technique for adjusting the power status of the base station by controlling to increase or decrease the cells constituting the wireless communication system, and a technique for turning off base stations with overlapped coverages and supporting services for terminals through cooperation among the base stations are used, and at this point, how to control the nodes (e.g., RAN, base stations, terminals, and the like) constituting the wireless communication system is one of the key factors that determine whether optimization can be performed well.

In controlling each node constituting the wireless communication system, the conventional method adopts a centralized control method as described above. For example, the centralized control method assumes that a central processing node, which is an upper node of a base station, specifies a transmission and reception relation between each base station and each terminal. However, in the centralized control method, time delay occurs due to information exchange between a plurality of base stations and the central processing node, and improvement of overall network energy efficiency is limited due to the processing burden of the central processing node and consumption of resources for information exchange.

Accordingly, recent techniques for controlling wireless communication systems are getting out of the centralized method and adopt distributed optimization techniques that control the power of a plurality of base stations in a distributed manner. The distributed optimization techniques include Dual Decomposition, Message Passing Algorithm, and Alternating Direction Method of Multipliers. Effectiveness of these techniques for distributed network management has been proven in various networking applications. In addition, recently, advancement in the approach using deep learning techniques is opening a new research paradigm for network management application programs.

Meanwhile, in a hierarchical network where cooperation among nodes is allowed only in a hierarchical manner between masters and slaves, since a node may interact only with nodes in successive tiers, there is a characteristic in that priorities are given among the nodes in each tier, and heterogeneous node tasks are generated in each tier. In addition, as each node in a hierarchical network has a different environment and a partly different role performed according thereto, there are difficulties in implementing a distributed deep learning framework applying a distributed method for an arbitrary hierarchical network configuration.

Therefore, it needs to develop an integrated network management framework that can be uniformly applied to any hierarchical network while considering the characteristics of hierarchical networks.

### SUMMARY OF THE INVENTION

Therefore, the present invention has been made in view of the above problems, and it is an object of the present invention to provide a neural network model learning technique for each node constituting a hierarchical tree-structured network based on a distributed learning framework that can be uniformly applied to any hierarchical network while considering the characteristics of the hierarchical network in which a node may interact only with nodes in successive tiers in a network of a hierarchical structure where cooperation among nodes is allowed only in a hierarchical manner between masters and slaves.

Meanwhile, the technical problems of the present invention are not limited to the technical problems mentioned above, and unmentioned other technical problems will be clearly understood by those skilled in the art from the following description.

To accomplish the above object, according to one aspect of the present invention, there is provided a method performed by a neural network model learning apparatus operated by a processor, the method comprising the steps of: creating nodes and edges constituting a hierarchical tree-structured system and assigning local information to each node; arranging, in each node, a first neural network including parameters for generating upward information transferred from a first node to a parent node, a second neural network including parameters for the first node to generate control information to be executed by the first node, and a third neural network including parameters for generating downward information transferred from the first node to child nodes; and learning the parameters of the first, second, and third neural networks to maximize an expected value of the system according to a result of receiving the upward information and the downward information on the basis of the first, second, and third neural networks and determining control information to be executed on its own local information by each node constituting the hierarchical tree structure.

In addition, the first neural network may be set to generate second upward information to be transferred to the parent node according to the parameters learned on the basis of first upward information transferred from a child node and local information of the first node.

In addition, the first node may be set to derive, when the first node has a plurality of child nodes, a plurality of information according to the first neural network on the basis of the first upward information transferred from each child node and the local information of the first node, and generate one piece of second upward information by integrating the plurality of information on the basis of a predetermined integration function.

In addition, the second neural network may be set to determine control information to be executed by the first node according to parameters learned on the basis of the first upward information transferred from the child node, first downward information transferred from the parent node, and the local information of the first node.

In addition, the first node may be set to generate, when the first node has a plurality of child nodes, first upward information obtained by integrating upward information transferred from each child node according to a predetermined integration function, and the second neural network may be set to determine control information to be executed by the first node according to the parameters learned on the basis of the integrated first upward information, first downward information transferred from the parent node, and its own local information.

In addition, the third neural network may be set to generate second downward information to be transferred to a child node according to parameters learned on the basis of the first upward information transferred from the child node, the first downward information transferred from the parent node, the local information of the first node, and the control information of the first node.

In addition, the first node may be set to generate, when the first node has a plurality of child nodes, a plurality of second downward information to be transferred to each child node according to the third neural network on the basis of the first upward information transferred from each child node, the first downward information transferred from the parent node, its own local information, and control information determined by itself.

In addition, the step of assigning local information may include the steps of: determining the number of tiers in the hierarchical tree structure; determining the number of nodes in each tier; and arranging nodes in each tier according to the number of tiers and the number of nodes in each tier, and connecting edges between nodes of upper and lower tiers.

In addition, the step of determining the number of nodes in each tier may include the step of setting a minimum value and a maximum value of the number of nodes in at least any one tier, the step of connecting edges may include the step of creating a plurality of hierarchical tree structures according to each number of cases between the minimum value and the maximum value of the number of nodes in at least any one tier, and the step of learning the parameters of the first, second, and third neural networks may include the step of learning the parameters of the first, second, and third neural networks by applying the first, second, and third neural networks to the plurality of hierarchical tree structures.

In addition, the step of learning the parameters of the first, second, and third neural networks may include the step of setting the parameters of the first, second, and third neural networks embedded in all nodes of the hierarchical tree structure to be learned equally.

In addition, the step of learning the parameters of the first, second, and third neural networks may include the step of setting the parameters of the first, second, and third neural networks embedded in the nodes of the same tier of the hierarchical tree structure to be learned equally, and setting the parameters of the first, second, and third neural networks embedded in the nodes of different tiers of the hierarchical tree structure to be learned differently.

To accomplish the above object, according to one aspect of the present invention, there is provided a neural network model learning apparatus comprising: a memory for storing instructions; and a processor for performing a predetermined operation on the basis of the instructions, wherein the operation of the processor includes the steps of: creating nodes and edges constituting a hierarchical tree-structured system and assigning local information to each node; arranging, in each node, a first neural network including parameters for generating upward information transferred from a first node to a parent node, a second neural network including parameters for the first node to generate control information to be executed by the first node, and a third neural network including parameters for generating downward information transferred from the first node to child nodes; and learning the parameters of the first, second, and third neural networks to maximize an expected value of the system according to a result of receiving the upward information and the downward information on the basis of the first, second, and third neural networks and determining control information to be executed on its own local information by each node constituting the hierarchical tree structure.

### BRIEF DESCRIPTION OF THE DRAWINGS

FIG. 1 is an exemplary view showing a wireless communication system having a hierarchical tree structure according to an embodiment.

FIG. 2 is a block diagram showing the configuration of a neural network model learning apparatus according to an embodiment.

FIG. 3 is a flowchart illustrating the steps of an operation performed by a neural network model learning apparatus according to an embodiment.

FIG. 4 is an exemplary view showing a hierarchical tree structure in which the configuration and connection form of a wireless communication system is implemented as nodes and edges according to an embodiment.

FIGS. 5, 6 and 7 are exemplary views showing an operation of generating upward information, control information, and downward information using a first neural network, a second neural network, and a third neural network, and transferring the information among connected nodes, by a first node according to an embodiment.

FIGS. 8 and 9 are exemplary views showing an operation of receiving upward information, determining control information to be executed on its local information, and transferring downward information, by each node from the perspective of the entire nodes in the hierarchical tree structure according to an embodiment.

FIG. 10 is an exemplary view showing an embodiment in which parameters of a first neural network, a second neural network, and a third neural network embedded in all nodes of a hierarchical tree structure are uniformly learned according to an embodiment.

FIG. 11 is an exemplary view comparing performance of the model with that of an existing technique at a node of tier 2 according to the embodiment of FIG. 10.

FIG. 12 is an exemplary view comparing performance of the model with that of an existing technique at a node of tier 3 according to the embodiment of FIG. 10.

FIG. 13 is an exemplary view showing an embodiment in which parameters of a first neural network, a second neural network, and a third neural network are differently learned in each tier of a hierarchical tree structure according to an embodiment.

FIG. 14 is an exemplary view comparing performance of the model with that of an existing technique at a node of tier 2 according to the embodiment of FIG. 13.

FIG. 15 is an exemplary view comparing performance of the model with that of an existing technique at a node of tier 3 according to the embodiment of FIG. 13.

### DETAILED DESCRIPTION OF THE PREFERRED EMBODIMENT

Details of the objects and technical configurations of the present invention and operational effects according thereto will be more clearly understood 1 by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, various embodiments the of present invention are described with reference to the accompanying drawings. However, this is not intended to limit the present invention to specific embodiments, but should be understood to include various modifications, equivalents, and/or alternatives of the embodiments of the present invention.

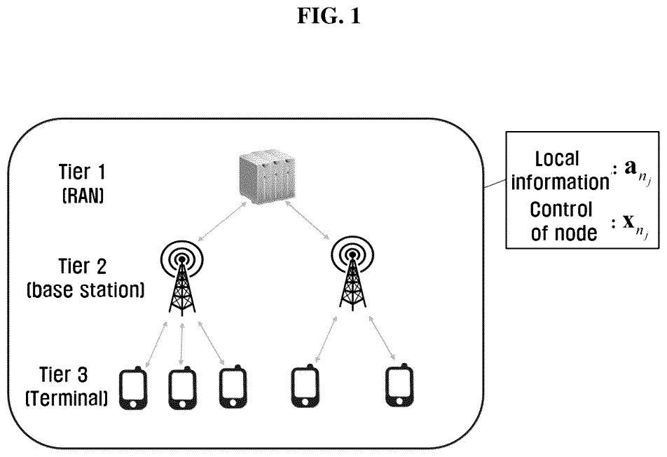

FIG. 1 is an exemplary view showing a wireless communication system having a hierarchical tree structure according to an embodiment.

Referring to FIG. 1, a wireless communication system of an example may be configured of ‘tier 1: RAN, tier 2: base stations, tier 3: terminals’, and the configuration of each tier may be connected through a backhaul link. At this point, when the configuration of each tier is regarded as a node and the connection of the backhaul link is regarded as an edge, the wireless communication system of FIG. 1 is a hierarchical tree structure, which corresponds to a system of a structure configured by connecting child nodes under a parent node using edges.

The wireless communication system of a hierarchical tree structure is required to support higher data rates to meet the demand for new and diverse services. Meanwhile, as consumption of network energy increases significantly to improve the data rate of the wireless communication system, network operators are seeking methods for improving and optimizing energy efficiency environmentally and economically sustainable while supporting the new and diverse services.

The wireless communication system of a structure like this may optimize the system environment by controlling Xₙ_{ⱼ} each node according to the local information aₙ_{ⱼ} of the nodes (e.g., tier 1: RAN, tier 2: base stations, tier 3: terminals, and the like) in each tier.

For example, optimization may be performed through a technique of controlling Xₙ_{ⱼ} power status of each base station on the basis of local information aₙ_{ⱼ} of each base station constituting the wireless communication system, a technique of controlling Xₙ_{ⱼ} to increase or decrease cells on the basis of local information aₙ_{ⱼ} of each base station constituting the wireless communication system, and a technique of supporting services for terminals through cooperation among base stations by controlling Xₙ_{ⱼ} power status of base stations in the overlapping coverages on the basis of local information aₙ_{ⱼ} of each base station, and at this point, how to control Xₙ_{ⱼ} each node according to the local information aₙ_{ⱼ} of the nodes of each tier constituting the wireless communication system is a key factor that determines whether optimization can be performed well.

In this way, the conventional method adopts a centralized control method in controlling the nodes constituting the wireless communication system. The centralized control method assumes that a central processing node, which is an upper node of a base station, specifies a transmission and reception relation between each base station and each terminal. Meanwhile, in the centralized control method, time delay occurs due to information exchange between a plurality of base stations and the central processing node, and improvement of overall network energy efficiency is limited due to the processing burden of the central processing node and resource consumption for information exchange.

Accordingly, recent techniques for controlling wireless communication systems are getting out of the centralized method and adopt distributed optimization techniques that control the power of a plurality of base stations in a distributed manner. The distributed optimization techniques include Dual Decomposition, Message Passing Algorithm, and Alternating Direction Method of Multipliers. Effectiveness of these techniques for distributed network management has been proven in various networking applications. In addition, recently, advancement in the approach using deep learning techniques is opening a new research paradigm for network management application programs.

Meanwhile, in a hierarchical network where cooperation among nodes is allowed only in a hierarchical manner between masters and slaves, since a node may interact only with nodes in successive tiers, there is a characteristic in that priorities are given among the nodes in each tier, and heterogeneous node tasks are generated in each tier. In addition, as each node in a hierarchical network has a different environment and a partly different role performed according thereto, it is required to provide a technique for implementing a distributed deep learning framework applying a distributed method for an arbitrary hierarchical network configuration.

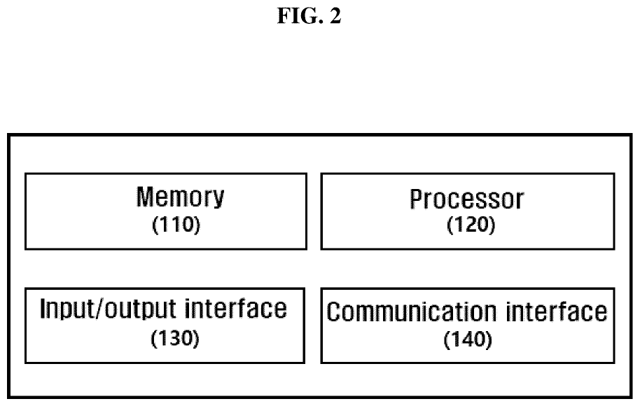

Accordingly, the embodiment of this document proposes below, through FIGS. 2 to 15, a neural network model learning technique for each node constituting a hierarchical tree-structured network based on a distributed learning framework that can be uniformly applied to any hierarchical network while considering the characteristics of the hierarchical network in which a node may interact only with nodes in successive tiers in a hierarchical network where cooperation among nodes is allowed only in a hierarchical manner between masters and slaves.

FIG. 2 is a block diagram showing the configuration of a neural network model learning apparatus 100 (hereinafter, referred to as an ‘apparatus 100’) according to an embodiment.

Referring to FIG. 2, the apparatus 100 according to an embodiment may include a memory 110, a processor 120, an input/output interface 130, and a communication interface 140.

The memory 110 may store data acquired from an external device or data generated by itself. The memory 110 may store instructions that can perform the operations of the processor 120. In addition, the memory 110 may store information on predetermined wireless communication system and information on a hierarchical tree structure in which the wireless communication system is implemented as nodes and edges.

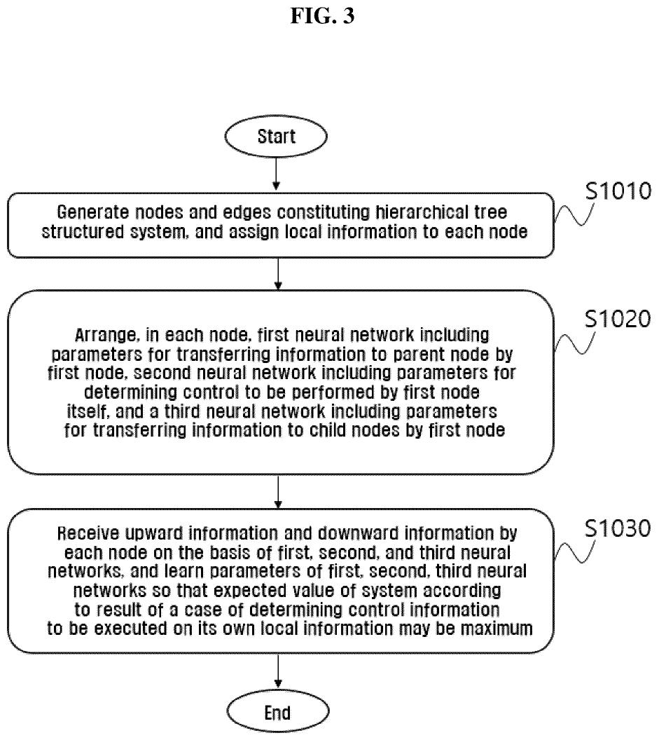

The processor 120 is a computing device that controls overall operations. The processor 120 may execute the instructions stored in the memory 110. According to an embodiment of this document, the operation of the apparatus 100 of FIG. 3 described below may be understood as an operation performed by the processor 120.

The input/output interface 130 may include a hardware interface or a software interface that inputs or outputs information.

The communication interface 140 allows transmission and reception of information through a communication network. To this end, the communication interface 140 may include a wireless communication module or a wired communication module.

The apparatus 100 may be implemented in various types of devices capable of performing calculation through the processor 120 and transmitting and receiving information through a network. For example, the apparatus 100 may be implemented in the form of a server, a computer device, a portable communication device, a smart phone, a portable multimedia device, a laptop computer, a tablet PC, or the like, but it is not limited to these examples.

FIG. 3 is a flowchart illustrating operations performed by the apparatus 100 according to an embodiment. The operation of the apparatus 100 according to the embodiment of FIG. 3 may be understood as an operation performed by the processor 120.

Each step disclosed in FIG. 3 is only a preferred embodiment in achieving the objects of the present invention, and some steps may be added or deleted as needed, and any one step may be performed to be included in another step. The order of the steps disclosed in FIG. 3 is merely an order arranged for convenience of understanding, and this order is not limited to a time-series order, and the order may be changed to operate differently according to selection of a designer.

Referring to FIG. 3, at step S1010, the apparatus 100 may create a hierarchical tree structure reflecting the configuration and connection form of a predetermined wireless communication system. For example, the apparatus 100 may create a hierarchical tree structure by representing the configuration in each tier included in the wireless communication system as nodes and representing the backhaul link of each node as edges. The apparatus 100 may assign local information to each node and simulate a result according to control of a node on each local information.

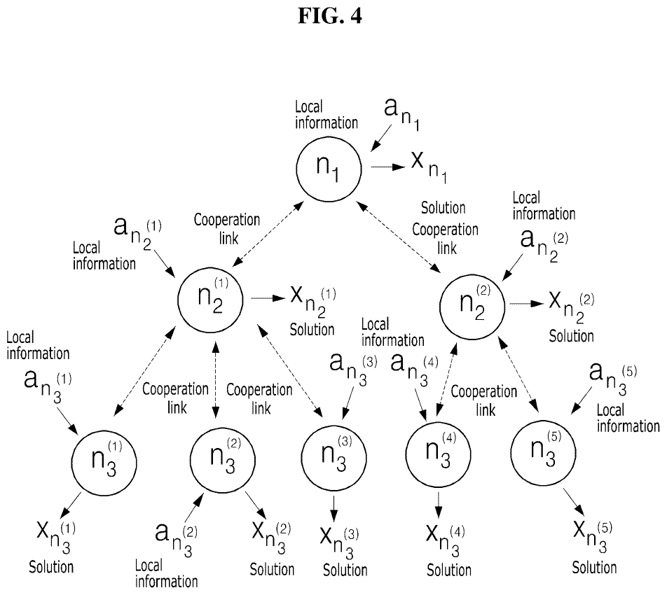

FIG. 4 is an exemplary view showing a hierarchical tree structure in which the configuration and connection form of a wireless communication system is implemented as nodes and edges according to an embodiment.

Referring to FIG. 4, the apparatus 100 may create a hierarchical tree structure by generating configurations in each tier of the wireless communication system of FIG. 1 as nodes and connecting the connection form between the configurations of the wireless communication system of FIG. 1 using edges. In addition, the apparatus 100 may assign local information to each node.

In FIG. 4, nⱼⁱ denotes identification information of a node, j denotes identification information of a tier, i denotes identification information of each node in a specific tier, aₙ_{ⱼ}_{ⁱ} denotes local information of node nⱼⁱ, and Xₙ_{ⱼ}_{ⁱ} denotes control information of node nⱼⁱ. In the drawings, a parent node of any one node nⱼ (hereinafter, referred to as a ‘first node’) located in tier j is denoted as pₙ_{ⱼ}, and a child node of node nⱼ located in tier j is denoted as c or d.

At step S1020, the apparatus 100 may arrange a first neural network, a second neural network, and a third neural network in each node, and allow the nodes to exchange information with each other through operations of the first neural network, the second neural network, and the third neural network described below.

For example, when information that the first node transfers to the parent node is referred to as upward information, the apparatus 100 may create a first neural network including parameters for generating uplink information that the first node will transfer to the parent node.

For example, when an operation performed by the first node according to its local information is referred to as control information, the apparatus 100 may create a second neural network including parameters for generating control information to be executed by the first node.

For example, when information that the first node transfers to a child node is referred to as downward information, the apparatus 100 may create a third neural network including parameters for generating downward information that the first node will transfer to the child node.

The first neural network, the second neural network, and the third neural network are models learned on the basis of a predetermined machine learning algorithm, and may include the overall of a model having problem-solving capability, which is configured of artificial neurons that form a network through combination of synapses. Artificial neural networks may be designed according to connection patterns between neurons in different layers, a learning process that updates model parameters, and an activation function that generates output values.

An artificial neural network may include an input layer, an output layer, and optionally one or more hidden layers. Each layer includes one or more neurons, and the artificial neural network may include synapses connecting the neurons. In an artificial neural network, each neuron may output a function value of the activation function with respect to input signals input through the synapse, a weight, and a bias.

The model parameters refer to parameters determined through learning and may include weights of synapse connections, biases of neurons, and the like. In addition, hyperparameters refer to parameters that should be set before learning in a machine learning algorithm, and may include a learning rate, the number of learning times (epoch), a batch size, an initialization function, and the like.

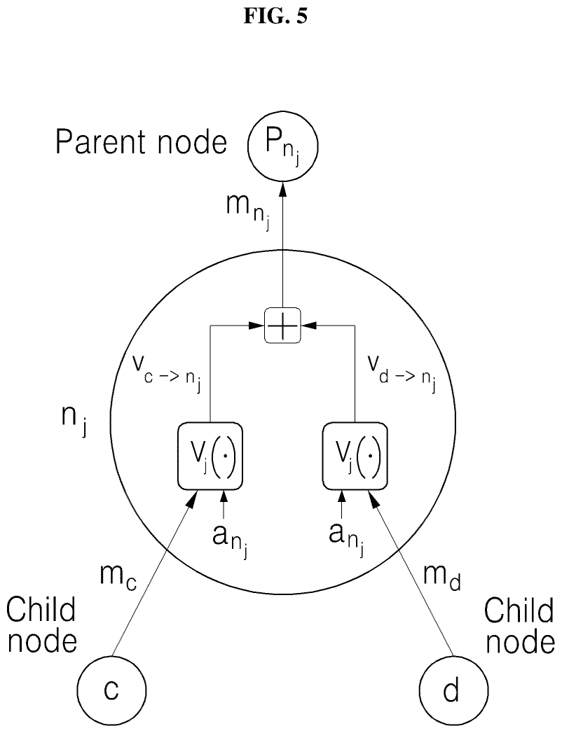

The first node may be set to perform an operation according to FIGS. 5, 6, and 7, the first neural network, the second neural network, and the third neural network arranged in the first node.

FIGS. 5, 6, and 7 are exemplary view showing an operation of generating upward information, control information, and downward information using a first neural network, a second neural network, and a third neural network, and transferring the information among connected nodes by a first node according to an embodiment.

FIGS. 5, 6, and 7 are exemplary view showing an operation of receiving first upward information of a child node and transferring second upward information to the parent node, by a first node.

Referring to FIG. 5, when the first neural network Vⱼ(.) receives first upward information m_{c} and m_{d} transferred from the child nodes c and d and local information aⱼ of the first node, the first node may generate second upward information mₙ_{ⱼ} to be transferred to the parent node pₙ_{ⱼ} according to the learned parameters. At this point, when the first node has a plurality of child nodes c and d, the first node may be set to derive information V_{c→n}_{ⱼ} and V_{d→n}_{ⱼ} on the basis of the first upward information m_{c} and m_{d} transferred from the child nodes and the local information aⱼ of the first node, and generate one piece of second upward information mₙ_{ⱼ} by integrating the information according to a predetermined integration function. The first node may transfer the second upward information mₙ_{ⱼ} to the parent node as upward information.

Meanwhile, the integration function may include a pooling operation function for generating an output unrelated to the dimension and permutation. For example, the pooling operation function may include sum-pooling, average-pooling, and max-pooling. For example, when the sum-pooling operation function is used, the second upward information mₙ_{ⱼ} may be generated as shown in Equation 1.

$${m}_{{n}_{j}} = {\sum }_{c ∈ {C}_{{n}_{j}}} {V}_{c \to {n}_{j}} = {\sum }_{c ∈ {C}_{{n}_{j}}} {V}_{j} ( {a}_{{n}_{j}} , {m}_{c} ) \qquad [ Equation 1 ]$$

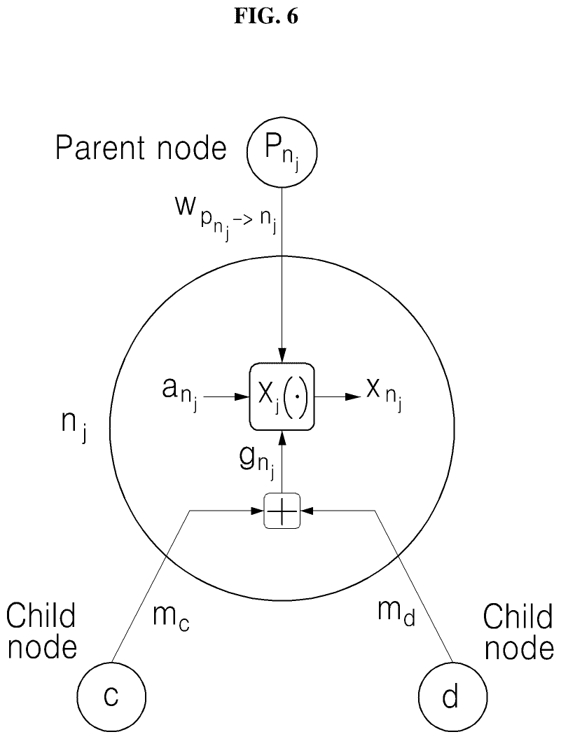

FIG. 6 is an exemplary view showing an operation of generating control information by a first node.

Referring to FIG. 6, when the second neural network Xⱼ(.) receives first upward information m_{c} and m_{d} transferred from the child nodes c and d, first downward information

$${w}_{{p}_{{n}_{j}} -> {n}_{j}}$$

transferred from the parent node pₙ_{ⱼ}, and local information aⱼ of the first node, the first node may generate control information Xₙ_{ⱼ} to be executed by the first node according to the learned parameters. At this point, when the first node has a plurality of child nodes c and d, the first node may be set to generate first upward information gₙ_{ⱼ} integrating the upward information m_{c} and m_{d} transferred from the child nodes according to a predetermined integration function (e.g., the integration function described above), and the second neural network may be set to determine control information Xₙ_{ⱼ} to be executed by the first node according to the parameters learned on the basis of the integrated first upward information gₙ_{ⱼ} the first downward information

$${w}_{{p}_{{n}_{j}} - > {n}_{j}}$$

transferred from the parent node, and the local information of the first node.

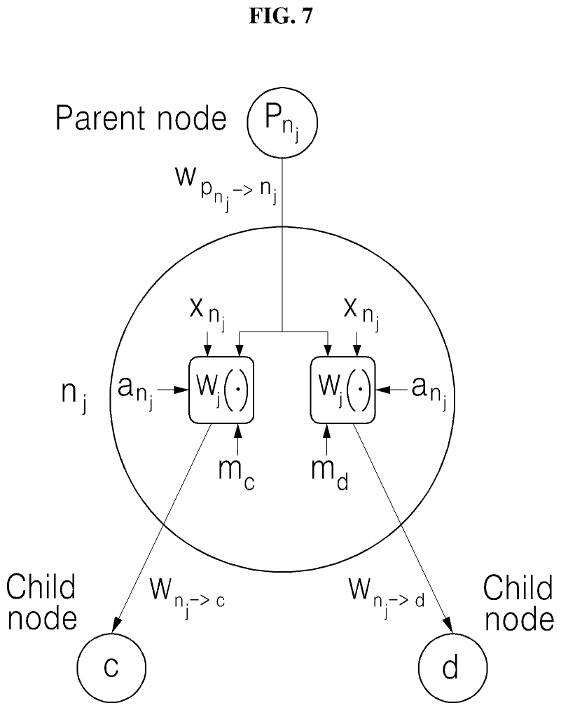

FIG. 7 is an exemplary view showing an operation of receiving first downward information of the parent node and transferring second downward information to child nodes, by a first node.

Referring to FIG. 7, when the third neural network Wⱼ(.) receives first upward information m_{c} and m_{d} transferred from the child nodes c and d, first downward information

$${w}_{{p}_{{n}_{j}} - > {n}_{j}}$$

transferred from the parent node pₙ_{ⱼ} local information aⱼ of the first node, and control information Xₙ_{ⱼ} of the first node, the first node may generate second downward information to be transferred to the child nodes according to the learned parameters. At this point, when the first node has a plurality of child nodes c and d, the first node may be set to generate second downward information Wₙ_{ⱼ}_{→c}_{ⱼ} and Wₙ_{ⱼ}_{→d} to be transferred to each child node according to the third neural network on the basis of the first upward information m_{c} and m_{d} transferred from the child nodes, first downward information

$${w}_{{p}_{{n}_{j}} - > {n}_{j}}$$

transferred from the parent node, and its own local information aⱼ, and its own control information Xₙ_{ⱼ}.

Accordingly, the apparatus 100 may allow each node constituting the hierarchical tree structure to receive upward information and downward information from the nodes connected through the edges on the basis of the first neural network, the second neural network, and the third neural network operating according to FIG. 5 described above, and determine control information to be executed on its own local information.

Meanwhile, description of FIG. 5 explains that the embodiment of this document is performed from the perspective of the first node, which is any one node, and the operation of this document may be explained as shown in FIGS. 6 and 7 from the perspective of the entire hierarchical tree structure.

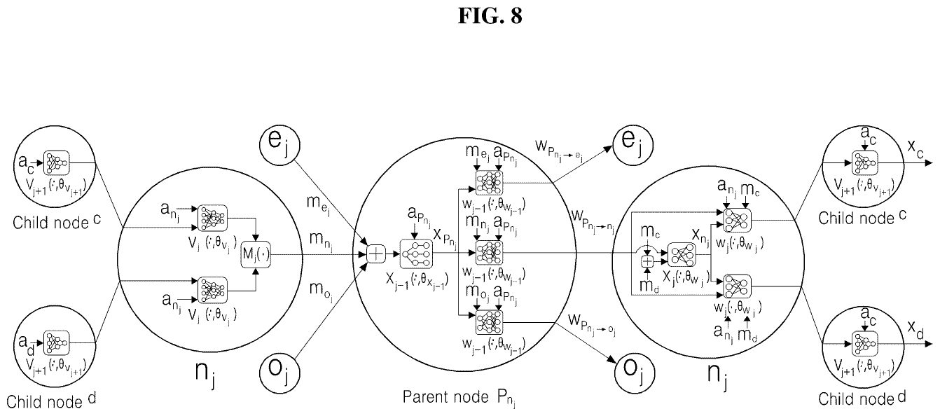

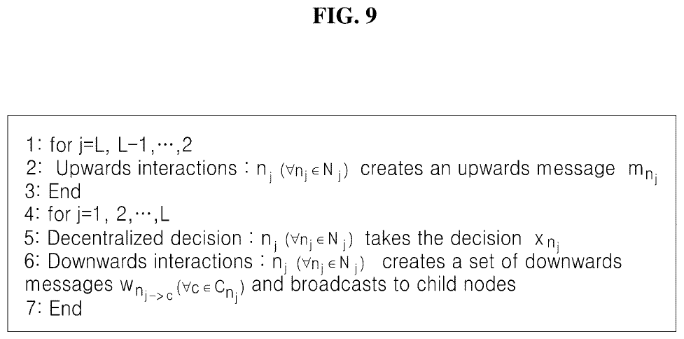

FIGS. 8 and 9 are exemplary views showing an operation of receiving upward information, determining control information to be executed on its local information, and transferring downward information, by each node from the perspective of the entire nodes in the hierarchical tree structure according to an embodiment.

Referring to FIGS. 8 and 9, when there are L tiers (L is a natural number equal to or greater than 2), the operation of FIG. 5 of transferring upward information from tier 2 to tier 1 may be performed by performing an operation of transferring upward information from tier L, which is the lowest tier, to tier L−1 according to the operation described in FIG. 5. At this point, since a leaf node among the nodes does not have a child node, the value input as upward information of a child node may be treated as null in the operation of a neural network corresponding to the leaf node.

Thereafter, the operation of FIG. 6 and the operation of FIG. 7 are performed successively in one tier. That is, a root node corresponding to tier 1 may determine control information by performing the operation of FIG. 6, and immediately thereafter, the root node may transfer downward information from tier 1 to the child nodes of tier 2 by performing the operation of FIG. 7. The operation of FIG. 6 and the operation of FIG. 7 may be performed in both tier L−1 and tier L. At this point, since the root node among the nodes does not have a parent node, the value input as downward information of the parent node may be treated as null in the operation of a neural network corresponding to the root node.

When the operation of FIGS. 8 and 9 are performed, each node determines control information to be executed on its local information on the basis of the parameters of the first neural network, the second neural network, and the third neural network, and the apparatus 100 may derive a result value (e.g., in the case where power of each node is controlled according to the local information of each node in a wireless communication system, a result value of improved energy efficiency in the entire system) of the entire hierarchical tree structure system based on the control information determined by each node. For example, the apparatus 100 may set up a simulation of the system having an environment the same as that set at step S1010, and derive a result value by performing a simulation of executing the control information determined according to an embodiment of this document.

At step S1030, the apparatus 100 may learn each node constituting the hierarchical tree structure to learn the parameters of the first, second, and third neural networks so that the expected value of the tree structure system may be maximized in the result value derived when each node executes the control information determined on the basis of the first neural network, the second neural network, and the third neural network. For example, the apparatus 100 may set an objective function of each node so that the expected value of the entire system resulting according to the control information determined by each node may be maximized when local information is given to each node. Accordingly, each neural network model may learn (e.g., supervised learning) the parameters of each neural network model to minimize the loss function for the difference between the output value of each neural network that maximizes the expected value of the system and an actual correct answer value that maximizes the expected value of the system. For example, the first neural network, the second neural network, and the third neural network may update the weights in a direction that minimizes the slope of the loss function at the learning step, and this may be achieved through an error backpropagation process of each learning step.

The embodiment of this document may improve performance of the overall system by applying a first neural network Vⱼ(.), a second neural network Vⱼ(.), and a third neural network Vⱼ(.) of each tier that have learned the parameters through steps S1010 to S1030 described above to the nodes of an actual wireless communication system so that each node is allowed to derive optimal control information according to its local information.

Meanwhile, although the operations of steps S1010 to S1030 are described as learning the first neural network, the second neural network, and the third neural network of each node on the basis of any one hierarchical tree structure for convenience of understanding, in the embodiment of this document, the first neural network, the second neural network, and the third neural network may be learned on the basis of a plurality of hierarchical tree structures of different forms so that an additional embodiment may be configured to apply the first neural network, the second neural network, and the third neural network created through the learning to an arbitrary hierarchical structure.

As an additional embodiment, at step S1010, the apparatus 100 may create a plurality of hierarchical tree structures through an operation of determining a range of the number of tiers in a hierarchical tree structure, determining a range of the number of nodes in each tier, arranging nodes in each tier according to the specified number of tiers and the specified number of nodes in each tier, within the range of the number of tiers and the range of the number of nodes in each tier, and connecting edges between nodes of upper and lower tiers according to a predetermined rule (e.g., random connection, connection of 1 to 5 edges per node, or the like). For example, the apparatus 100 may set a minimum value and a maximum value of the number of nodes in at least any one tier, and create a plurality of hierarchical tree structures according to each number of cases between the minimum value and the maximum value of the number of nodes in at least any one tier.

Accordingly, the apparatus 100 may learn the parameters of the first neural network Vⱼ(.), the second neural network Vⱼ(.), and the third neural network Vⱼ(.) that can be applied to an arbitrary hierarchical structure by applying the first neural network Vⱼ(.), the second neural network Vⱼ(.), and the third neural network Vⱼ(.) in each case of the plurality of hierarchical tree structures created at step S1010, and performing learning in the plurality of hierarchical tree structures according to the operations of steps S1020 and S1030.

At step S1030, the apparatus 100 may set the parameters of the first neural network Vⱼ(.), the second neural network Vⱼ(.), and the third neural network Vⱼ(.) embedded in all nodes of the hierarchical tree structure to be equally learned regardless of a hierarchy. In this case, regardless of j that means a tier, the parameters of the first neural network have the same value for all tiers.

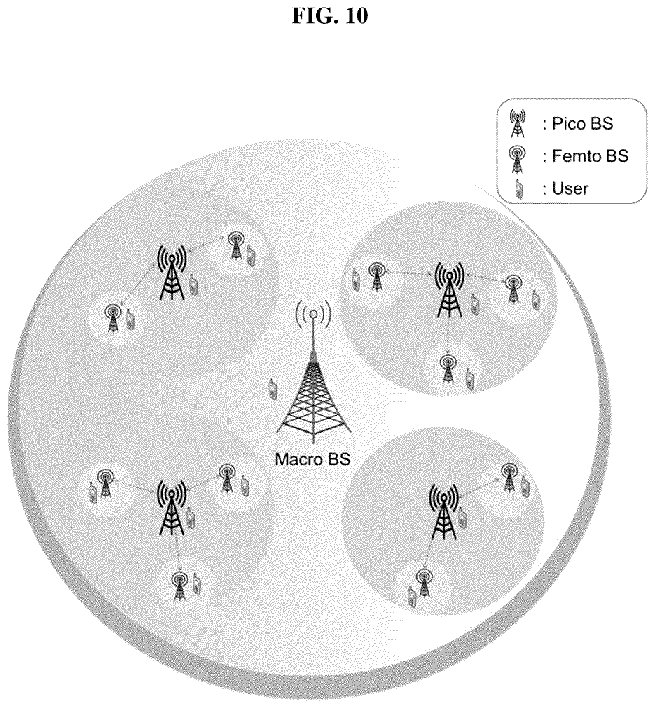

FIG. 10 is an exemplary view showing an embodiment in which parameters of a first neural network, a second neural network, and a third neural network embedded in all nodes of a hierarchical tree structure are uniformly learned according to an embodiment.

FIG. 10 shows an example of a wireless communication system configured of a Macro BS, Pico BSs, Femto BSs, and users. Assuming that the operating environment and method of each node are similar, all nodes have performed learning by uniformly setting the parameters of the first neural network, the second neural network, and the third neural network to be equal regardless of tiers. The result according to this embodiment is shown in FIGS. 10 to 12.

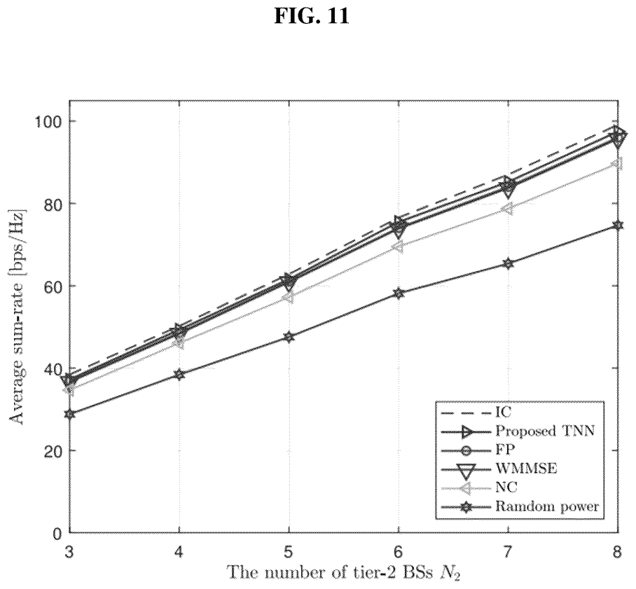

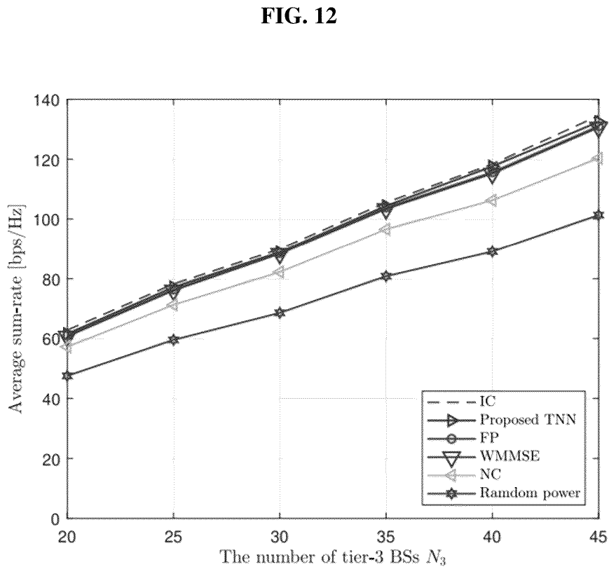

FIG. 11 is an exemplary view comparing performance of the model with that of an existing technique at a node of tier 2 according to the embodiment of FIG. 10, and FIG. 12 is an exemplary view comparing performance of the model with that of an existing technique at a node of tier 3 according to the embodiment of FIG. 10.

Referring to FIGS. 11 and 12, it can be confirmed that performance of the present invention (proposed TNN) according to an embodiment of FIG. 10 is almost similar to that of a centralized control method (IC) although a distributed optimization technique is used. That is, it can be confirmed that the present invention may exhibit performance corresponding to the centralized control method while determining control in a way much faster than that of the centralized control method.

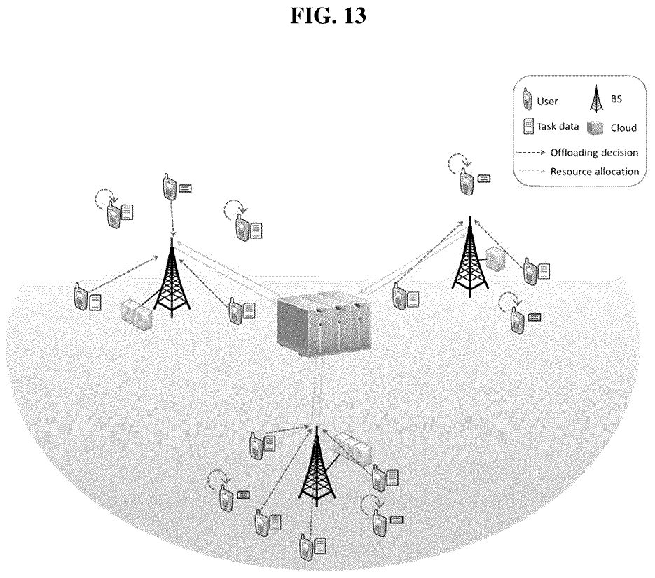

At step S1030, the apparatus 100 may set the parameters of the first, second, and third neural networks to be equal among the nodes of the same tier of the hierarchical tree structure, and set the parameters of the first, second, and third neural networks embedded in the nodes of different tiers of the hierarchical tree structure to be learned differently. In this case, this is a method in which the parameters of the first neural network of each tier are learned separately, and although the parameters of the first neural network included in the same tier j are equal, the parameters are different among the first neural networks of different tiers. A result according to this example is shown in FIGS. 13 to 15.

FIG. 13 is an exemplary view showing an embodiment in which parameters of a first neural network, a second neural network, and a third neural network are differently learned in each tier of a hierarchical tree structure according to an embodiment.

FIG. 13 shows an example of a wireless communication system configured of a cloud, BSs, users, and tasks. Assuming that the operating environment and method of each node are different, the first neural network, the second neural network, and the third neural network have performed learning to have different parameters for each tier.

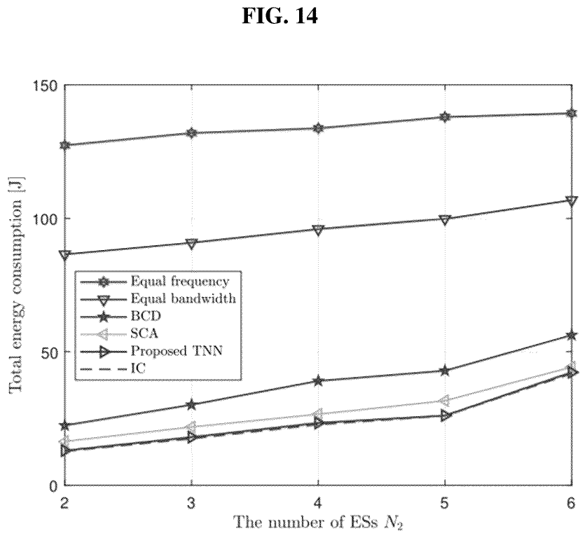

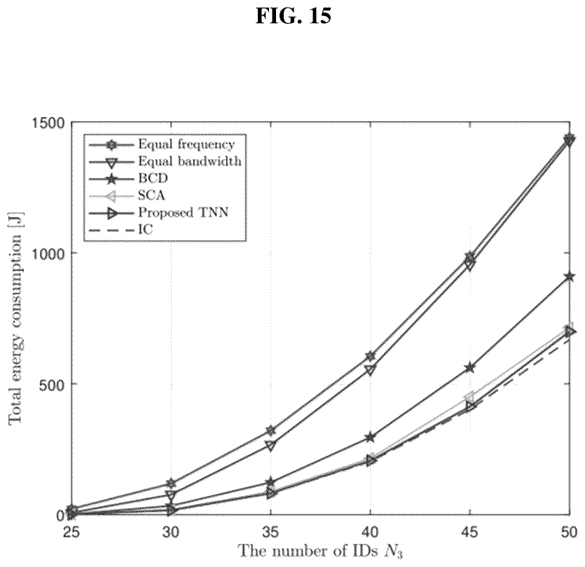

FIG. 14 is an exemplary view comparing performance of the model with that of an existing technique at a node of tier 2 according to the embodiment of FIG. 13, and FIG. 15 are exemplary view comparing performance of the model with that of an existing technique at a node of tier 3 according to the embodiment of FIG. 13.

Referring to FIGS. 14 and 15, it can be confirmed that performance of the present invention (proposed TNN) according to an embodiment of FIG. 13 is almost similar to that of a centralized control method (IC) although a distributed optimization technique is used. That is, it can be confirmed that the present invention may exhibit performance corresponding to the centralized control method while determining control in a way much faster than that of the centralized control method.

According to the embodiment described above, proposed is a flexible deep learning strategy for handling distributed optimization tasks in a multi-tier network arranged in a hierarchical structure where cooperation among nodes is allowed in a hierarchical manner between masters and slaves. Particularly, inference rules that can be applied to arbitrary network configurations according to the characteristic that backhaul connections between nodes are very diverse are needed in a realistic multi-tier network. To this end, the present invention may learn a neural network model for each node constituting a tree-structure network on the basis of cooperative inference rules for a random tree structure for the sake of hierarchical network optimization.

Accordingly, as the present invention can be uniformly applied to any hierarchical network while considering the characteristics of the hierarchical network in which a node may interact only with nodes in successive tiers in a hierarchical network, each node can be controlled to perform an operation for optimization for various forms of node configurations that constitute a wireless communication system.

Various embodiments of this document and terms used herein are not intended to limit the technical features described in this document to specific embodiments, and should be understood to include various changes, equivalents, or substitutes of corresponding embodiment. In relation to the description of drawings, similar reference numerals may be used for similar or related components. The singular form of a noun corresponding to an item may include one or a plurality of item unless a related context clearly dictates otherwise.

In this document, each of phrases such as “A or B”, “at least one among A and B”, “at least one among A or B”, “A, B or C”, “at least one among A, B and/or C”, “at least one among A, B or C” may include all possible combinations of items listed together in a corresponding phrase among the phrases. Terms such as “a first”, “a second”, “the first”, “the second”, and the like may be used simply to distinguish a corresponding component from another and do not limit corresponding components in different aspects (e.g., importance or sequence). When a certain component (e.g., a first component) mentioned to be “coupled” or “connected” to another component (e.g., a second component) with or without a term such as “functionally” or “communicatively”, this means that the certain component may be connected to another component directly (e.g., wiredly), wirelessly, or through a third component.

The term “module” used in this document may include units implemented in hardware, software, or firmware, and may be used interchangeably with the terms such as logic, logic blocks, parts, circuits, or the like. The module may be an integrated part, a minimum unit of a part that performs one or more functions, or a part thereof. For example, according to an embodiment, the module may be implemented in the form of an application-specific integrated circuit (ASIC).

Various embodiments of this document may be implemented as software (e.g., program) including one or more instructions stored in a storage medium (e.g., memory) that can be read by a device (e.g., electronic device). The storage medium may include random access memory (RAM), memory buffers, hard drives, databases, erasable programmable read-only memory (EPROM), electrically erasable read-only memory (EEPROM), read-only memory (ROM), and/or the like.

In addition, a processor in the embodiments of this document may call at least one instruction among one or more stored instructions from a storage medium and execute the instruction. This allows the device to be operated to perform at least one function according to the at least one instruction that is called. These one or more instructions may include a code generated by a compiler or a code that can be executed by an interpreter. The processor may be a general-purpose processor, a field programmable gate array (FPGA), an application specific integrated circuit (ASIC), a digital signal processor (DSP), and/or the like.

The storage medium that can be read by a device may be provided in the form of a non-transitory storage medium. Here, ‘non-transitory’ only means that the storage medium is a tangible device and does not include signals (e.g., electromagnetic waves), and this term does not distinguish between a case where data is stored semi-permanently in the storage medium and a case where data is stored temporarily.

Methods according to various embodiments disclosed in this document may be provided to be included in a computer program product. Computer program products are goods and may be traded between sellers and buyers. The computer program product may be distributed in the form of a storage medium that can be read by a device (e.g., compact disc read only memory (CD-ROM)) or may be distributed (e.g., downloaded or uploaded) through an application store (e.g., Play Store) or directly online between two user devices (e.g., smart phones). In the case of online distribution, at least some of computer program products may be at least temporarily stored or temporarily created in a storage medium that can be read by a device, such as a manufacturer's server, an application store's server, or a server's memory.

According to various embodiments, each component (e.g., module or program) among the components described above may include a single entity or a plurality of entities. According to various embodiments, one or more of the components or operations described above may be omitted, or one or more other components or operations may be added. In substitution or addition, a plurality of components (e.g., modules or programs) may be integrated into a single component. In this case, the integrated component may perform one or more functions of each of the plurality of components in a manner the same as or similar to those performed by a corresponding component of the plurality of components prior to integration. According to various embodiments, the operations performed by the modules, programs, or other components may be executed sequentially, in parallel, iteratively, or heuristically, or one or more of the operations may be executed in a different order or omitted, or one or more other operations may be added.

The present invention proposes a flexible deep learning strategy for handling distributed optimization tasks in a multi-tier network arranged in a hierarchical structure where cooperation among nodes is allowed in a hierarchical manner between masters and slaves. Particularly, inference rules that can be applied to arbitrary network configurations according to the characteristic that backhaul connections between nodes are very diverse are needed in a realistic multi-tier network. To this end, the present invention may learn a neural network model for each node constituting a tree-structure network on the basis of cooperative inference rules for a random tree structure for the sake of hierarchical network optimization.

Accordingly, as the present invention can be uniformly applied to any hierarchical network while considering the characteristics of the hierarchical network in which a node may interact only with nodes in successive tiers in a hierarchical network, each node can be controlled to perform an operation for optimization for various forms of node configurations that constitute a wireless communication system.

Meanwhile, the effects of the present invention are not limited to those mentioned above, and unmentioned other technical effects will be clearly understood by those skilled in the art from the following description.

### DESCRIPTION OF SYMBOLS

100: Apparatus
110: Memory
120: Processor
130: Input/output interface
140: Communication interface

What is claimed is:

1. A method performed by a neural network model learning apparatus operated by a processor, the method comprising the steps of:
creating nodes and edges constituting a hierarchical tree-structured system and assigning local information to each node;
arranging, in each node, a first neural network including parameters for generating upward information transferred from a first node to a parent node, a second neural network including parameters for the first node to generate control information to be executed by the first node, and a third neural network including parameters for generating downward information transferred from the first node to child nodes; and
learning the parameters of the first, second, and third neural networks to maximize an expected value of the system according to a result of receiving the upward information and the downward information on the basis of the first, second, and third neural networks and determining control information to be executed on its own local information by each node constituting the hierarchical tree structure.

2. The method according to claim 1, wherein the first neural network is set to generate second upward information to be transferred to the parent node according to the parameters learned on the basis of first upward information transferred from a child node and local information of the first node.

3. The method according to claim 2, wherein the first node is set to derive, when the first node has a plurality of child nodes, a plurality of information according to the first neural network on the basis of the first upward information transferred from each child node and the local information of the first node, and generate one piece of second upward information by integrating the plurality of information on the basis of a predetermined integration function.

4. The method according to claim 1, wherein the second neural network is set to determine control information to be executed by the first node according to parameters learned on the basis of the first upward information transferred from the child node, first downward information transferred from the parent node, and the local information of the first node.

5. The method according to claim 4, wherein the first node is set to generate, when the first node has a plurality of child nodes, first upward information obtained by integrating upward information transferred from each child node according to a predetermined integration function, and the second neural network is set to determine control information to be executed by the first node according to the parameters learned on the basis of the integrated first upward information, first downward information transferred from the parent node, and its own local information.

6. The method according to claim 1, wherein the third neural network is set to generate second downward information to be transferred to a child node according to parameters learned on the basis of the first upward information transferred from the child node, the first downward information transferred from the parent node, the local information of the first node, and the control information of the first node.

7. The method according to claim 6, wherein the first node is set to generate, when the first node has a plurality of child nodes, a plurality of second downward information to be transferred to each child node according to the third neural network on the basis of the first upward information transferred from each child node, the first downward information transferred from the parent node, its own local information, and control information determined by itself.

8. The method according to claim 1, wherein the step of assigning local information includes the steps of:
determining the number of tiers in the hierarchical tree structure;
determining the number of nodes in each tier; and
arranging nodes in each tier according to the number of tiers and the number of nodes in each tier, and connecting edges between nodes of upper and lower tiers.

9. The method according to claim 8, wherein the step of determining the number of nodes in each tier includes the step of setting a minimum value and a maximum value of the number of nodes in at least any one tier, the step of connecting edges includes the step of creating a plurality of hierarchical tree structures according to each number of cases between the minimum value and the maximum value of the number of nodes in at least any one tier, and the step of learning the parameters of the first, second, and third neural networks includes the step of learning the parameters of the first, second, and third neural networks by applying the first, second, and third neural networks to the plurality of hierarchical tree structures.

10. The method according to claim 1, wherein the step of learning the parameters of the first, second, and third neural networks includes the step of setting the parameters of the first, second, and third neural networks embedded in all nodes of the hierarchical tree structure to be learned equally.

11. The method according to claim 1, wherein the step of learning the parameters of the first, second, and third neural networks includes the step of setting the parameters of the first, second, and third neural networks embedded in the nodes of the same tier of the hierarchical tree structure to be learned equally, and setting the parameters of the first, second, and third neural networks embedded in the nodes of different tiers of the hierarchical tree structure to be learned differently.

12. A neural network model learning apparatus comprising:
a memory for storing instructions; and
a processor for performing a predetermined operation on the basis of the instructions, wherein
the operation of the processor includes the steps of:
creating nodes and edges constituting a hierarchical tree-structured system and assigning local information to each node;
arranging, in each node, a first neural network including parameters for generating upward information transferred from a first node to a parent node, a second neural network including parameters for the first node to generate control information to be executed by the first node, and a third neural network including parameters for generating downward information transferred from the first node to child nodes; and
learning the parameters of the first, second, and third neural networks to maximize an expected value of the system according to a result of receiving the upward information and the downward information on the basis of the first, second, and third neural networks and determining control information to be executed on its own local information by each node constituting the hierarchical tree structure.
